(19) United States
(12) Patent Application Publication
(10) Pub. No.: US 2025/0264443 A1
(43) Pub. Date: Aug. 21, 2025

(54) AUTOMATED EVALUATION OF USED SCREWS

(71) Applicant: Fraunhofer-Gesellschaft zur Förderung der angewandten Forschung e.V., München (DE)

(72) Inventor: Matthias Stammler, Bremerhaven (DE)

(21) Appl. No.: 18/251,215

(22) PCT Filed: Oct. 27, 2021
(86) PCT No.: PCT/EP2021/079800

§ 371 Date: Sep. 7, 2023

(30) Foreign Application Priority Data
Oct. 30, 2020 (DE) 10 2020 213 694.7

(51) Int. Cl. G01N 29/44

(52) U.S. Cl. CPC G01N 29/4427; G01N 2291/0289; G01N 2291/2691

(57) ABSTRACT

A method for automated testing of the reusability of components, in particular screws, which comprises the following steps:
sensory detection of a state of a component, wherein the state of the component is described by a plurality of features, the sensory detection is carried out by
   optical sensors, which detect the geometric dimensions of the component, external damage or deformation of the component, and a state of any coating,
   acoustic sensors, which detect damage to the material and the material quality, and
   spectrometers, which detect a material composition of the component;
comparison of the state with the states of comparison components stored in a database;
decision about a reusability of the component on the basis of the comparison of the state with the states of comparison components stored in a database; and
rejection or supply for reuse of the component on the basis of the decision.

### CROSS REFERENCED TO RELATED APPLICATIONS

This application is a national stage entry of PCT/EP2021/079800, internationally filed on Oct. 27, 2021, which claims priority to German Application No. 10 2020 213 694.7, filed Oct. 30, 2020, both of which are incorporated herein by reference in their entirety.

### TECHNICAL FIELD

The invention relates to a method for automated testing and evaluation of the state of components, in particular of screws, in order to reuse components evaluated as reusable. Furthermore, an automated system for carrying out the method is described.

### BACKGROUND

Screws are used in a wide range of applications to connect large machine parts and must thereby satisfy high demands with respect to their material properties. According to VDI Guideline 2230, screws that have been used once are not to be installed again, and must instead be recycled and melted as scrap. High costs thus arise, particularly in the case of large projects, for example, in wind turbines, in which several thousand large screws are installed.

However, experience has shown that a certain proportion of screws that have already been used are definitely suitable for safe reuse. However, this requires a reliable evaluation of the state of the screws and also for a large number of screws. Due to the reuse of screws, or also of other components, for example bolts or pins, which this enables, the costs for large technical projects may be significantly reduced.

### SUMMARY

One object of the subject matter of the present protection application is therefore to propose a method which enables a reliable and safe evaluation of the reusability of components based on their state detected by sensors.

This problem is solved by a method for automated testing of the reusability of components, in particular screws, comprises the following steps:
sensory detection of a state of a component, wherein the state of the component is described by a plurality of features, the sensory detection being carried out by
   optical sensors, which detect the geometric dimensions of the component, external damage or deformation of the component, and a state of any coating,
   acoustic sensors, which detect damage to the material and the material quality, and
   spectrometers, which detect a material composition of the component; comparison of the state with the states of comparison components stored in a database;
decision about a reusability of the component on the basis of the comparison of the state with the states of comparison components stored in a database; and
rejection or supply for reuse of the component on the basis of the decision.

The sensory detection of the state of a component is carried out by multiple sensors, which each non-destructively detect data about the state of the component. This may be measured, for example, by optical sensors; external damage, damage to coatings, deformations or cracks in the material may be determined. Conclusions may be drawn about inclusions in the material or cracks which are not located on the surface, using acoustic sensors based on ultrasound or acoustic resonance through propagation times of acoustic signals, in particular in combination with optically detected dimensions. The material composition of the component may be determined by a spectrometer. The material quality may thus be determined and the component may be compared with a predetermined specification. The most important data about the component to be tested may thus be detected in the interaction of the sensors.

This data is compared to the recorded states of comparison components, which are stored in a database. Algorithms may thereby be used, which assign one or more comparison components with the highest possible degree of conformity to the component to be tested based on its data. Different properties of the components may thereby be more or less strongly considered. Other methods may also be used in order to define, for example, intersections of the collected data with different comparison components, and in this way to obtain a decision about the reusability of the tested component.

The database, which is used for the comparison of the sensor-detected state of the component with comparison components, may thereby contain, in addition to the sensory detected data for the comparison components, in particular information about their usability. This information is determined in practical tests. In such tests, previously used components in different states and with different signs of wear are installed again in test machines, and mechanically loaded and exposed to controlled environmental influences, for example, temperature fluctuations or corrosion due to salt water. In order to simulate long-term use of these comparison components, the tests may take place under accelerated conditions. The behavior of the comparison components is recorded and evaluated with respect to the possibility of a safe reuse of the comparison component. This evaluation is stored in the database, together with the detected state, and is then used for evaluating the components to be tested.

In addition to the already described sensors, the sensory detection of the method may be carried out using tactile sensors. These likewise detect the geometric dimensions of the component to be tested, similarly to the optical sensors; however, may have a higher accuracy. In this way, even the smallest deviations from the target values of the component may be detected, for example, the tapering of a shaft of a screw due to load effects. In order to configure the sensory detection to be as reliable as possible, the method may additionally comprise an automatic cleaning of the components to be tested as the first process step. Such a cleaning is conceivable, for example, as a pass through a cleaning bath or an ultrasound cleaning.

If a sensory detection of the component is not possible, or a comparison with states stored in the database is not successful, then the component may be rejected. In particular, it may thereby be marked in order to undergo a manual test later, and/or be supplied to a practical test for determining its usability, as already described. In this way, the database may be expanded with previously missing information.

In the case of a successful test and evaluation of a component, the database may also be subsequently expanded by the recorded data of the component. As this expansion may only include sensory detected data and also the evaluation obtained from the comparison about the reusability of the component, this data may naturally not provide conclusive information about the long-term safe usability of the component, and is thereby only considered as a secondary source during the evaluation of further components. A complete record of the data of a component for the database, including the information about the safe usability, is only possible if the component is further tracked after the automated test. In order to enable tracking of a tested component, the claimed method may further comprise a step in which components, which tested successfully and were evaluated as safe for reuse, are provided with a marking which enables tracking. Such a marking might be, for example, a QR or barcode. Dot peening, scribing, or laser marking methods, for example, may be used for marking the components. During a later test or monitoring of the component in its use, the marking enables a newly obtained evaluation about its long-term usability to be assigned to the sensory detected data from the automated test process, and thus the database is expanded by additional, practically obtained information about the usability of the component.

In order to carry out the described method, a device is further claimed, which is designed to automatically carry out the method.

Such a device for automated testing of the reusability of components, in particular screws, comprises:
a sealed test chamber, in which environmental conditions, like lighting and temperature, may be determined,
a supply mechanism, via which a component is transported into the test chamber and is transported from one sensor to the next in the same,
multiple sensors, by means of which the state of the component is detected, at least one of which is
   an optical sensor,
   an acoustic sensor, and
   a spectrometer,
an evaluation unit which is designed to compare the state of the component with the states of comparison components stored in a database, and
a sorting mechanism, via which evaluated components may be rejected or supplied for reuse.

Since the system is located in a sealed chamber, this enables a precise detection of the states of test objects, as, for example, optical sensors depend on consistent lighting conditions in order to provide comparable data, and the use of acoustic sensors requires defined, consistent temperatures.

A conveyor belt, for example, may be suitable for the supply and transport mechanism; however, other implementations, like robotic arms, roller conveyors, or the like, are also conceivable. The supply and transport mechanism may additionally be designed to position the component to be tested for the test, and to rotate it, when needed. Furthermore, the supply and transport mechanism may be suitable for detecting data, for example, the weight of a component to be tested.

The evaluation unit may be, for example, a computer, which has access to a database of comparison components and their states, and executes a program for comparing the detected states with the stored states. However, other embodiments for this task are also conceivable, like specialized circuits or networked systems.

The database in this device may also contain, in addition to purely sensory detected data for the comparison components, information about their usability, which was determined in practical tests, as already described.

The device may further comprise a tactile sensor. This may precisely detect the geometric dimensions of the component and any deviations of the dimensions of the component from their target values.

The device may additionally comprise an automated cleaning device. This may be, for example, a cleaning bath, through which the supply mechanism, for example in the form of a conveyor belt, transports the components to be tested before they are supplied to the sensors.

In order to enable the most efficient testing of the components, the supply mechanism is to be configured to enable the testing of a large number of components. This is particularly relevant for the testing of screws, which are installed in large numbers. One simple technical solution, which enables the transport of large numbers of components, is the use of a conveyor belt.

Furthermore, the supply mechanism and sorting mechanism may be designed such that components, whose state may not be detected by a sensor due to soiling or unknown influences, may be rejected directly downstream of this sensor. In this way, a pre-sorting of the components to be tested may occur and thus a testing of the components may also be achieved which is faster and more efficient overall.

In addition, the claimed device may comprise an apparatus for marking the components supplied for reuse. Such an apparatus may be, for example, a device for dot peening, scribing, or laser marking. As already described, marking of the tested components allows tracking of the components, and also a subsequent expansion of the database with respect to the long-term usability of the components.

The described embodiments of the subject matters of the present application may thereby be used, both individually and also in combination, in order to achieve additional effects and to provide a reliable and safe method for evaluating the reusability of components, in particular screws, and a device for carrying out this method.

### BRIEF DESCRIPTION OF THE DRAWINGS

The mentioned and further aspects of the invention will be shown by way of the detailed description of the embodiments, which are provided with the aid of the following drawings, of which:

FIG. 1 shows a flowchart of the process of the claimed method,

FIG. 2 is a schematic depiction of one embodiment of a device for automated testing of the reusability of screws, and

FIG. 3 is a schematic depiction of another embodiment of a device for automated testing of the reusability of screws.

In the following, the claimed method and the claimed subject matter will be explained in greater detail on the basis of the accompanying drawings. Identical reference numerals thereby relate to identical elements.

### DETAILED DESCRIPTION

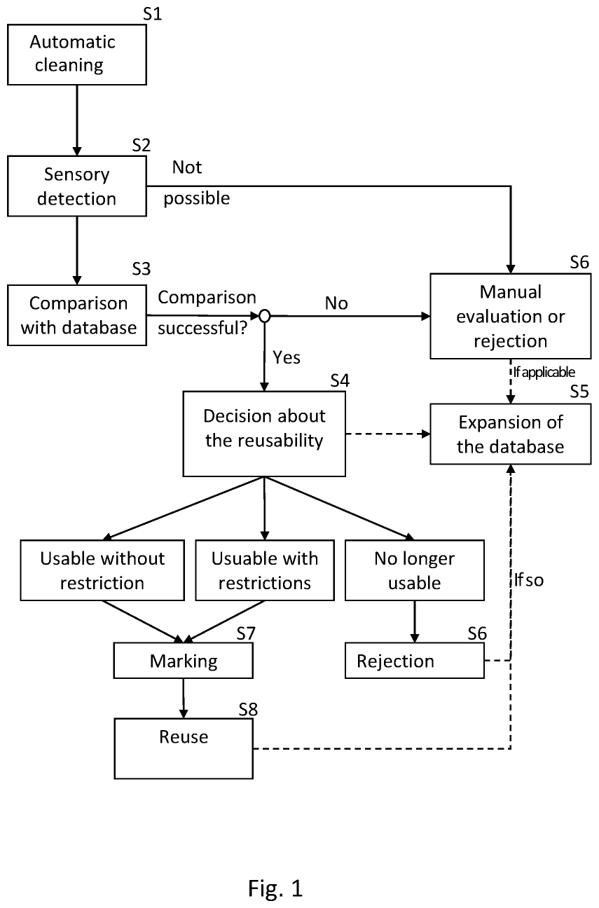

A method for automated testing of the reusability of components is depicted in FIG. 1. In order to guarantee a problem-free and reliable sensory detection of the state of a component, this is initially automatically cleaned in method step S1. This may take place, for example, through the use of a cleaning bath, through which the components to be tested are automatically transported. In this way, any soiling on the surface or residual lubricants may be removed, which might impair the subsequent sensory detection S2.

In method step S2, the actual sensory detection of the component is carried out. At least three different sensor units are thereby to be used, namely an optical sensor, an acoustic sensor, and a spectrometer. A tactile sensor may additionally be used. All sensors used thereby carry out non-destructive measurements. Using the example of screws, the following measurements may thereby be carried out: The screws may be measured by optical sensors: external damage to the threads, damage to the coating, deformation of the screw shaft, and cracks in the material may be determined. Tactile sensors likewise detect the geometric dimensions of the screws; however, they generally have a higher precision than optical sensors, and may thus also detect the smallest deviations, as may occur, for example, on a shaft of a screw under load. Conclusions may be drawn about inclusions in the material or cracks which are not located on the surface, using acoustic sensors based on ultrasound or acoustic resonance through propagation times of acoustic signals through the screw. The material composition of the screw may be determined by a spectrometer. Even if this method step is explicitly described here for screws, it may also be used for other components in a practically unchanged form, wherein the exact processes possibly need to be adjusted for the respective geometries.

The most important data about the component to be tested may thus be detected in the interaction of the sensors. The detection of the component by these sensors may occur in any sequence, or also at least partially simultaneously. It may be particularly advantageous, for example, if the measurement of the geometry of the component is carried out by an optical sensor before the examination of the component using ultrasound, as a propagation time measurement of the ultrasound signals requires information about the dimensions of the component in order to make statements about the material properties.

If a sensory detection may not be carried out due to remaining soiling, damage to the component that is too great, or for another reason, then the possibility exists here to reject the component S6 so that it does not need to pass through further method steps. If the different detections are carried out one after the other by the sensors, then, in this case, the component also does not need to pass through all of the sensors before it is rejected. In method step S3, a comparison is carried out of the detected state of the component to be tested with a database. This contains the states of comparison components, which were detected by sensors of the same type and under the same conditions.

In addition, the database contains an evaluation of the usability for each of its comparison components. This was respectively obtained in specific practical tests. The comparison components are previously used components in different states, which were installed again and were subsequently exposed to different loads. These also include, in addition to mechanical loads, which the component would be exposed to in its conventional use, loads due to environmental conditions, like temperature fluctuations, corrosion, and the like. These loads may take place in an accelerated form in order to simulate long-term use of the comparison component. The behavior of the comparison component is observed during the test and its state afterward is detected again in order to determine whether the component still meets the requirements for safe usability. On this basis, an evaluation is assigned to the comparison component on a scale of “usable without restriction” to “no longer usable”.

In comparison step S3, an attempt is made to assign the highest possible degree of conformity of states of comparison components in the database to the sensory detected state of the component. For this purpose, the individual, sensory detected properties of the component are compared using an algorithm. These properties include the geometric dimensions of the component, external signs of wear, like deformation, signs of abrasion, indications of corrosion and material fatigue, damage in certain areas of the component, like on any coatings, and signs of internal changes of the component, like inclusions, invisible cracks, or changes to the material composition.

If a comparison is not possible, or the degree of conformity remains below a certain limit, then the component is rejected in method step S6 or allocated to a manual evaluation. It is also possible that such a component is used for already described practical tests as a comparison component in order to gain additional data regarding usability for the database.

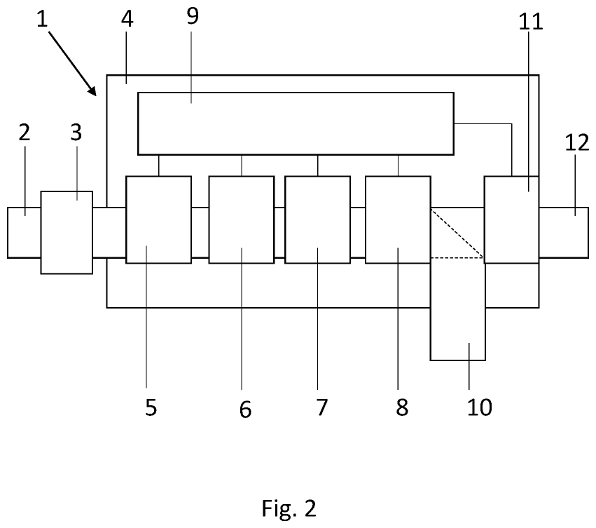

If the degree of conformity of the state of the component with the state of a comparison component or states of several comparison components stored in the database exceeds a fixed limit, then the comparison is successful. In the case of a successful comparison, the method is continued in step S4, in which a decision is made about the reusability of the component. This is made based on information about the usability, which is stored in the database, for the comparison component or the several comparison components with the highest degree of conformity. An evaluation is thus likewise assigned to the component, in which, in the embodiment shown in FIG. 2, it is assigned to one of three categories, “usable without restriction”, “usable with restrictions”, or “no longer usable”. However, it is also possible to assign a detailed evaluation, for example, according to suitability for certain usage applications or according to the time frame in which the component may be reused.

If it was decided that the component may be reused in any form, then it is supplied for reuse S8. If it may not be reused, then it is again rejected S6.

In parallel to method steps S4, S6, and S8, an expansion of the database S5 may take place in each case. The dashed arrows in FIG. 1 are thereby to indicate that the component is not forwarded to this step, but instead the data about the detected state of the component. In this step, the detected state of the component is likewise stored in the database so that this may be used as a comparison component for later evaluations. In addition to this data, other data may also be stored in the database, like, in the case of screws, maximum loads and information that is necessary for tightening screws. However, it should be noted that the information about the usability of the component is initially not assured for these new comparison components in the database, as this has not yet been practically confirmed. In the case of a rejected component, this evaluation is obtained in that it is used for practical tests regarding usability, instead of being supplied to scrap.

For components, which are to be directly reused, this step S5 is more difficult to configure and requires the possibility for tracking the component, even after longer reuse. In order to facilitate this, the components classified as reusable are marked in a method step S7. For marking, a barcode, a QR code, or another machine-readable marking may be used, for example, which is applied to the component by means of scribing, dot peening, laser marking, or another marking method. Such a marking ought to be of lasting durability and not susceptible to environmental influences relevant to the component. In this way, the component may also be tracked after longer reuse and a subsequent evaluation about its usability may be supplemented.

In FIG. 2, a device 1 for carrying out the described method is schematically depicted in a strongly simplified way. This is an embodiment, in which the components to be tested, in this case screws, are introduced into device 1 via a conveyor belt 2 on the left side of the figure and initially pass through a cleaning bath 3. Afterwards, the screws are transported into the actual main part of the device, which is located in a sealed test chamber 4. As test chamber 4 is separated from the surroundings, conditions, like temperature and lighting, may be controlled and held constant in it, so that the sensors provide reliable and comparable results. In the embodiment shown, the screws to be tested pass through several test stations, one station with optical sensors 5, one station for tactile sensors 6, one station with acoustic sensors 7, and one station that includes a spectrometer 8. Conveyor belt 2 is configured in the area of the test stations such that the screws to be tested are positioned and aligned for detection by the respective sensors. Test stations 5, 6, 7, and 8 send the recorded data to an evaluation unit 9. This is a computer which has access to a database of states of comparison components and executes a program to compare and evaluate the components. According to the method described above, the screw to be tested, after it has passed through last test station 8 and is thus completely sensory detected, is compared with the states of the comparison components stored in the database and evaluated on the basis of its reusability in evaluation unit 9. If it is classified as no longer usable, then it rejected via sorting mechanism 10. If the screw is classified as usable, then it is transported to the apparatus for marking 11. This may be a device for scribing, dot peening, laser marking, or another device for marking. As this embodiment concerns the testing and evaluation of screws, the marking must be able to be applied on a small surface, for which reason a QR code, for example, is suitable. Apparatus 11 is supplied with the data necessary for tracking the screws by evaluation unit 9. The screws thus marked leave test chamber 4 and may be supplied from outlet 12 of the device for reuse. It is not shown in FIG. 2, that another sorting may take place at outlet 12, if the screws classified as reusable are to be additionally evaluated against further criteria, like material quality, duration of usability, or usage purpose.

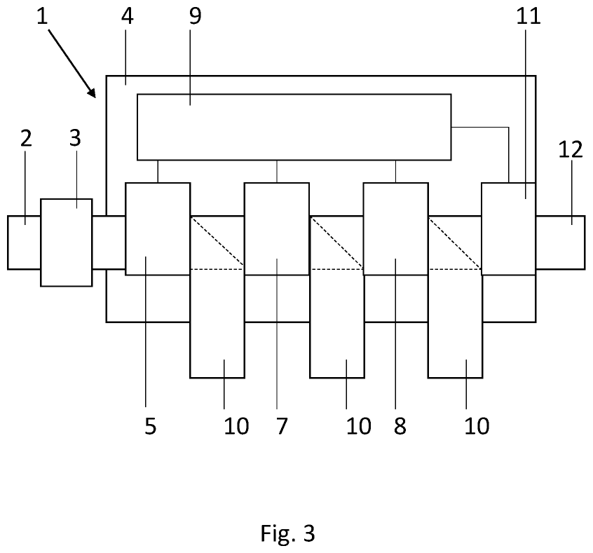

A similar device for testing screws is shown in FIG. 3. Unlike FIG. 2, this embodiment only uses three different sensors, in this case, optical and acoustic sensors and a spectrometer. In addition, sorting mechanism 10 is designed to reject screws, which may not be detected by a sensor, directly downstream of this sensor. In this way, components, which, for example do not pass an optical test due to soiling or severe damage, do not need to pass through the entire sensory detection, by which means the number of tested screws may be increased per time interval. This embodiment is naturally also conceivable with further sensors. It is likewise possible that the sorting mechanism is only designed for rejecting downstream of one or several of the sensors, for example, only downstream of the optical sensor. The embodiments shown here are not limiting. In particular, the features of these embodiments may be combined with one another to achieve additional effects. It is clear for a person skilled in the art that changes to these embodiments may be carried out without leaving the basic principles of the subject matter of this protection application, whose scope is defined in the claims.

1.-14. (canceled)

15. A method for automated testing of the reusability of components, in particular screws, which comprises the following steps:
sensory detection of a state of a component (S2), wherein the state of the component is described by a plurality of features, the sensory detection being carried out by one or more optical sensors, which detect the geometric dimensions of the component, external damage or deformation of the component, and/or a state of any coating,
acoustic sensors, which detect damage to the material and the material quality, or
spectrometers, which detect a material composition of the component;
comparison (S3) of the state with the states of comparison components stored in a database;
decision (S4) about a reusability of the component on the basis of the comparison of the state with the states of comparison components stored in a database; and
rejection (S6) or supply for reuse (S8) of the component on the basis of the decision.

16. The method according to claim 15, characterized in that, for the comparison of the state of a component with states of comparison components stored in a database, the database contains information about the usability of the comparison components, which was determined in practical tests, in addition to sensory detectable data about the comparison components.

17. The method according to claim 15, characterized in that the sensory detection is additionally carried out by tactile sensors, which detect the geometric dimensions and deformations of the component.

18. The method according to claim 15, characterized in that the component is automatically cleaned (S1) before the sensory detection.

19. The method according claim 15, characterized in that, in the case that a comparison with states stored in the database is not possible, the component is rejected (S6) and/or is marked for a practical test regarding usability.

20. The method according to claim 15, characterized in that, after the decision about the reusability of the component, the database is expanded (S5) by the sensory detected state of the component.

21. The method according to claim 15, characterized in that a component, which is supplied for reuse, is provided with a marking (S7) for tracking.

22. A device for automated testing of the reusability of components (1),comprising:
a sealed test chamber (4), in which environmental conditions, may be determined;
a supply mechanism (2), via which a component is transported into the test chamber (4) and is transported from one sensor (5, 6, 7) to the next;
multiple sensors (5, 6, 7), by means of which the state of the component is detected, at least one of the sensors being
an optical sensor (5),
an acoustic sensor (6), or
a spectrometer (7);
an evaluation unit (8) which compares the state of the component with the states of comparison components stored in a database, and
a sorting mechanism (9), via which the evaluated components may be rejected or supplied for reuse.

23. The device according to claim 22, characterized in that the database contains information about the usability of the comparison components, which was determined in practical tests, in addition to sensory detectable data about the comparison components.

24. The device according to claim 22, characterized in that the multiple sensors additionally comprise at least one tactile sensor.

25. The device according to claim 22, characterized in that the device further comprises an automated cleaning device (3).

26. The device according to claim 22, characterized in that the supply mechanism (2) is configured to transport a large number of components to be tested into and through the device.

27. The device according to claim 22, characterized in that the supply mechanism (2) and the sorting mechanism (9) are designed to reject components whose state is not detectable by one of the multiple sensors (5, 6, 7).

28. The device according to claim 22, characterized in that the device comprises an apparatus for marking components supplied for reuse (10).

29. The device according to claim 28, wherein the apparatus for marking components is configured for scribing, dot peening, or laser marking components supplied for reuse.

30. The device according to claim 22, wherein the environmental conditions include lighting or temperature.

31. A device for automated testing of the reusability of a component, comprising:
a sealed test chamber;
a supply mechanism configured for transporting a component through the sealed test chamber;
at least one sensor configured for determining a state of the component;
an evaluation unit configured for comparing the state of the component with the states of comparison components stored in a database, and
a sorting mechanism configured for rejecting or supplying a component for reuse.

32. The device according to claim 31, wherein the at least one sensor comprises one or more optical sensor, acoustic sensor, spectrometer, or tactile sensor.

33. The device according to claim 31, further comprising an automated cleaning device.

34. The device according to claim 31, further comprising an apparatus for marking components.
